(19) United States
(12) Patent Application Publication
(10) Pub. No.: US 2007/0029943 A1
(43) Pub. Date: Feb. 8, 2007

(54) Ballast with lampholder arc protection

(76) Inventors: Robert A. Erhardt, Schaumberg, IL (US); Ernesto Mendoza, Elgin, IL (US)

Correspondence Address: PHILIPS INTELLECTUAL PROPERTY & STANDARDS, P.O. BOX 3001, BRIARCLIFF MANOR, NY, 10510, US

(21) Appl. No.: 10/571,168

(22) PCT Filed: Sep. 9, 2004
(86) PCT No.: PCT/IB04/51724

§ 371 Date: Mar. 9, 2006

Related U.S. Application Data
(60) Provisional application No. 60/502,313, filed on Sep. 12, 2003.

(51) Int. Cl. H05B 39/04

(52) U.S. Cl. 315/209 R

(57) ABSTRACT

The invention provides an electronic ballast for a fluorescent-lamp (20), including a fluorescent-lamp ballast circuit (30), an arc detection circuit (40) electrically connected to the fluorescent-lamp ballast circuit (30), and a lamp cutoff device (50) in series with the fluorescent (20) and electrically coupled to the arc detection circuit (40). The fluorescent-lamp ballast circuit (30) provides power to the fluorescent lamp (20). The lamp cutoff device (50) is opened when arcing is detected by the arc detection circuit (40).

This invention relates generally to an electronic ballast for starting and controlling a gas-discharge lamp or a fluorescent lamp, and more particularly, to an electronic ballast with arc protection for instant-start fluorescent lamps.

A fluorescent lamp is a high-efficiency gas discharge lamp that uses an electric discharge through low-pressure mercury vapor to produce ultraviolet (UV) energy. The ultraviolet energy excites phosphorescent materials applied as a thin layer on the inside of a glass tube and the phosphors transform the UV to visible light. Ballasts for fluorescent lamps provide high ignition voltages for starting the lamp and control power delivery during lamp operation. The ignition voltages of instant-start type ballasts may exceed 800 volts peak and as a result, fluorescent lamps are subject to the problem of output arcing. Typical fluorescent lamps operate with an alternating voltage of several hundred volts with a frequency usually of more than 30 KHz. Filaments constituting electrodes at opposite ends of the lamp alternately serve as electron-emitting cathodes in each frequency cycle.

The instant-start type of fluorescent-lamp ballast is designed to start fluorescent lamps as soon as power is applied. Instant-start circuits, which were originally developed to eliminate separate mechanical starter devices, are generally more appropriate in lighting applications with longer burn cycles such as continuous 24-hour operation or with limited on-and-off switching. Today, T8-style instant-start ballasts are the most popular type of ballast on the market because of their features of high-efficiency, ease of installation, moderate cost, and independent lamp operation, the latter improving system safety by providing light from functioning lamps when an individual lamp ceases operation. Instant-start ballasts require only one pin at each end of the fluorescent lamp, though can be used with lamps having heatable filaments and two pins at each end if the lamps are rated accordingly by the lamp manufacturer.

Potential arcing within lampholders of instant-type ballasts is a phenomenon that is being recognized as an undesirable effect to be mitigated. Traditional instant-start ballasts with parallel lamp operation apply a constant high voltage when the output is open and an arc may occur when, for example, an intermittent connection occurs between the lamp and lamp sockets. It is possible for momentary output arcing to occur in fluorescent lighting installations when failed lamps are replaced while AC power is applied to the ballast, the arc being formed between the fixture socket contacts and a pin of the lamp. Arcing may not only cause degradation of the contacts in the fixture sockets and undue stress on components within the ballast, but also the potential for overheating of lamp sockets.

In recent years, the lighting industry has been developing technology to sense potential arcing conditions and shut down a lighting system before arcing becomes a problem. Underwriters Laboratories gives a Class CC rating to ballasts with anti-arcing protection.

Non-arcing cap holders have been designed for fluorescent lamps that can be used in harsh environmental conditions. Burwell and others disclose a lamp holder assembly with waterproof and insulative characteristics in “Non-Arcing Fluorescent Lamp Holder”, U.S. Pat. No. 6,193,534 issued Feb. 27, 2001. The fluorescent lamp holder assembly is adapted to receive various injection-molded end cap structures, and in a preferred embodiment includes a fluorescent lamp surrounded by a protective sleeve. A first end cap covers a first end of the lamp and sleeve, while a second end cap structure comprising a tube power connector cap covers a second end of the lamp and sleeve. The interior of each cap holder, also referred to as a receptacle, may be shrouded to discourage electrical arcing and to allow the receptacle to flex. The end caps are preferably watertight.

While more complex and costly solutions have been used to produce anti-arcing CC ratings for instant-start ballasts, a need exists for an instant-start CC-rated electronic fluorescent ballast that can be incorporated into existing ballast designs with minimal impact on other features and functions of the ballast. The improved ballast would incorporate good end-of-life and auto-restart features that eliminate the need to reset power breakers after failed lamps are replaced. It would also provide desirable ballast system and method for reducing and preventing arcing in discharge lamps that are efficient, cost-effective and work with most power-supply circuits and fluorescent lamps.

One aspect of the invention is an electronic ballast for a fluorescent lamp, including a fluorescent-lamp ballast circuit, an arc detection circuit, and a lamp cutoff device. The fluorescent-lamp ballast circuit provides power to the fluorescent lamp. The arc detection circuit is electrically connected to the fluorescent-lamp ballast circuit. The lamp cutoff device is in series with the fluorescent lamp and electrically coupled to the arc detection circuit. When the arc detection circuit detects arcing, the lamp cutoff device is opened.

Another aspect of the invention is an arc protection circuit for a fluorescent lamp, including an arc detection circuit and a lamp cutoff device in series with the fluorescent lamp and electrically coupled to the arc detection circuit. The lamp cutoff device is opened when the arc detection circuit detects arcing.

Another aspect of the invention is a method of operating a fluorescent lamp with steps to monitor for an arcing condition, and switch off power to the fluorescent lamp when the arcing condition is detected.

Another aspect of the invention is an arc protection circuit for a fluorescent lamp, including an arc detection circuit and means for reducing lamp power supplied to the fluorescent lamp. The arc detection circuit is connected in series with the fluorescent lamp and is responsive to an interruption of current through the fluorescent lamp as an indication of arcing. Lamp power is reduced to the fluorescent lamp when the interruption of current through the fluorescent lamp is detected.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

Various embodiment of the present invention are illustrated by the accompanying figures, wherein:

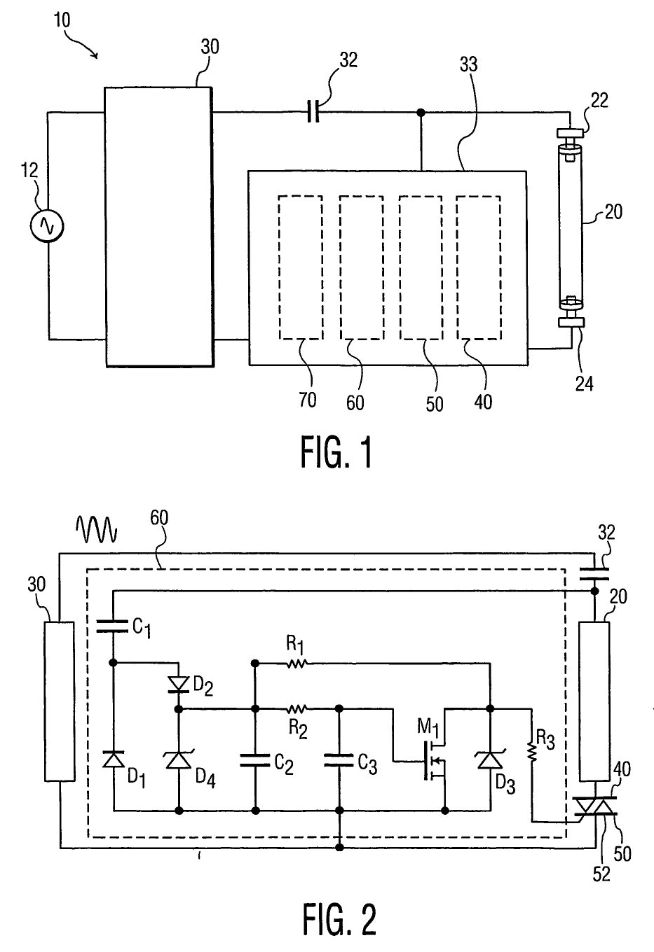

FIG. 1 is a block diagram of an electronic ballast for a fluorescent lamp, in accordance with one embodiment of the current invention;

FIG. 2 is a schematic diagram of an arc protection circuit for a fluorescent lamp, in accordance with one embodiment of the current invention;

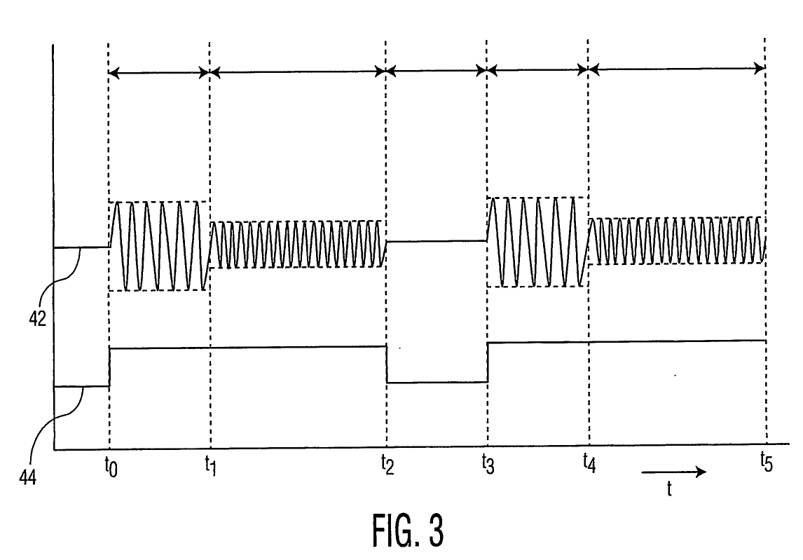

FIG. 3 is a timing diagram for an electronic ballast with lampholder arc protection, in accordance with one embodiment of the current invention; and

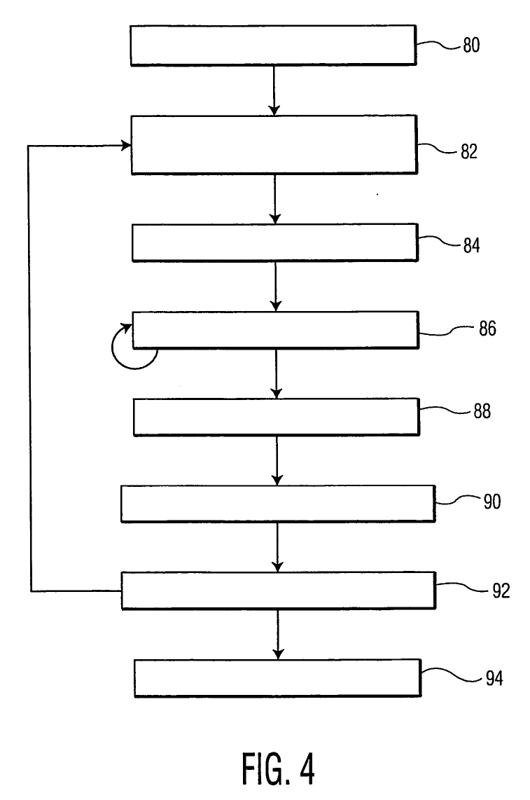

FIG. 4 is a flow diagram of a method of operating a fluorescent lamp, in accordance with one embodiment of the current invention.

FIG. 1 shows a block diagram of an electronic ballast 10 for a fluorescent lamp 20, in accordance with one embodiment of the present invention. Electronic ballast 10 includes a fluorescent-lamp ballast circuit 30 and an arc prevention circuit 33 containing an arc detection circuit 40 and a lamp cutoff device 50, arc prevention circuit 33 being electrically connected in series between fluorescent-lamp ballast circuit 30 and fluorescent lamp 20. Lamp cutoff device 50 is electrically coupled to arc detection circuit 40. Electronic ballast 10 with arc detection circuit 40 and lamp cutoff device 50 may be used to provide arc protection for fluorescent lamps operating with instant start, programmed start, rapid start, and other types of ballast circuits. Electronic ballast 10 may be connected to one or a set of fluorescent lamps 20. In one embodiment, electronic ballast 10 detects arcing in a lamp socket, takes appropriate action to extinguish the arc, and then switches the lamp power back on after sufficient time has passed to extinguish the arc.

Fluorescent lamp 20 can have one or two pins at each end; a single pin at each end is needed for instant-start operation, whereas a set of pins at each end provide for electrical connections to the filaments and for application of high voltage across the terminal pins of fluorescent lamp 20. Lampholders 22 and 24 are located at each end of fluorescent lamp 20, providing electrical contact to the pins at the end of fluorescent lamp 20. Lampholders 22, 24 allow fluorescent lamp 20 to be installed and removed as desired, and provide mechanical support for fluorescent lamp 20. Because the electrical contacts within lampholders 22, 24 can oxidize or loosen, a localized arc between lampholder 22, 24 and the pins at the ends of fluorescent lamp 20 sometimes forms when high voltage is applied to fluorescent lamp 20.

Fluorescent-lamp ballast circuit 30 provides power to one or more fluorescent lamps 20, starting fluorescent lamps 20 in either an instant-start or programmed-start mode, and then controlling the power to sustain the arc with the lamps. As is well known in the art, this type of circuit comprises an AC-to-DC converter for generating a DC voltage from an AC line supply 12, and a controlled-frequency inverter circuit to drive the fluorescent lamps at a prescribed voltage and frequency. The output circuit includes an impedance element to limit current to the lamp. A ballast capacitor 32 is connected between the outputs of fluorescent-lamp ballast circuit 30 and fluorescent lamp 20 to act as an impedance element to limit current to the lamp in the embodiment of FIG. 1.

Arc detection circuit 40 detects arcing that can occur between lampholders 22, 24 and fluorescent lamp 20. Arc detection circuit 40 detects a lampholder arcing condition such as a lamp overvoltage condition or an interrupted lamp-current condition. A lamp overvoltage condition may occur, for example, when an intermittent arc occurs between fluorescent lamp 20 and lampholder 22, 24 and a voltage is generated across the ends of fluorescent lamp 20 that can exceed 600 volts or more. An interrupted lamp current condition may occur, for example, when an intermittent arc occurs and the lamp current is interrupted. Lamp cutoff device 50 is opened, for example, when arcing is detected with arc detection circuit 40.

A control signal is applied to lamp cutoff device 50 from arc prevention circuit 33 to allow the lamp to turn on or to keep the lamp turned off. A lamp-on control signal applied to an input control terminal of lamp cutoff device 50, for example, turns on lamp cutoff device 50 and allows current to flow, whereas a lamp-off control signal turns off lamp cutoff device 50 and blocks current from flowing through fluorescent lamp 20. In one example, lamp cutoff device 50 comprises a high-voltage triac. In another example, lamp cutoff device 50 comprises a power metal-oxide-semiconductor field-effect transistor (MOSFET), a transistor in a diode bridge arrangement, or other power device or power device configuration. Electronic components such as resistors, capacitors, diodes and transistors are used to bias and provide appropriate signal levels and timing to lamp cutoff device 50. With a triac, for example, high rates of current change (di/dt) occur with large ballast voltages at relatively high ballast output frequencies across the output terminals of the triac, maintaining the triac in an on or closed condition while lamp current continues to flow, acting as a lamp-on control signal. When current is interrupted, the lack of current acts as a lamp-off control signal for triac conduction.

Arc detection and protection may be implemented using other types of bi-directional switching devices that have circuitry to detect an interruption of current and/or an increase in lamp voltage above the normal operating range of the lamp.

In an alternative construction, circuitry maintains connection of fluorescent lamp 20 for a predetermined period of time after electronic ballast 10 is first turned on before blocking lamp cutoff device 50 between fluorescent lamp 20 and fluorescent-lamp ballast circuit 30 to guarantee proper ignition of fluorescent lamp 20.

Arc prevention circuit 33 may contain a lamp cutoff delay circuit 60. Lamp cutoff delay circuit 60 is electrically connected to lamp cutoff device 50. Lamp cutoff delay circuit 60 provides a lamp-on control signal to lamp cutoff device 50 to maintain lamp cutoff device 50 in a closed condition during a predetermined startup period. During initial startup, for example, lamp cutoff delay circuit 60 provides a lamp-on control signal to lamp cutoff device 50 for a period of 100 milliseconds or longer to ensure that fluorescent lamp 20 has a sufficiently long period of time to ignite and turn on, even if an intermittent lampholder arc occurs. Lamp cutoff delay circuit 60 may comprise, for example, a charging network, a monostable multivibrator, or a timing chip to achieve the desired delay period.

Arc prevention circuit 33 may also contain a lamp restart circuit 70. Lamp restart circuit 70 is electrically connected to lamp cutoff device 50. Lamp restart circuit 70 provides a lamp-on control signal to lamp cutoff device 50 when a predetermined lamp restart delay period has expired. For example, after an arc has been detected and power to fluorescent lamp 20 has been removed, an attempt may be made automatically to restart the lamp. The lamp-restart delay period may exceed, for example, ten seconds to allow an arc in the lampholder to diminish and any heat generated in the lampholder to dissipate. The delay period may be generated, for example, with a timing circuit or a timing chip.

In another embodiment, an arc protection circuit including arc detection circuit 40 in series with fluorescent lamp 20 is responsive to an interruption of current through fluorescent lamp 20 indicating arcing. Lamp power supplied to fluorescent lamp 20 is reduced when the interruption of current through fluorescent lamp 20 is detected, such as by blocking power to fluorescent lamp 20 with lamp cutoff device 50 when the arcing condition is detected or by reducing the voltage applied to fluorescent lamp 20 from fluorescent-lamp ballast circuit 30.

FIG. 2 shows a schematic diagram of an arc protection circuit for a fluorescent lamp 20, in accordance with one embodiment of the present invention. The arc protection circuit includes a triac 52 functioning as an arc detection circuit 40 and as a lamp cutoff device 50, and a lamp cutoff delay circuit 60. When ballast circuit 30 applies power through ballast capacitor 32, it generates a DC voltage across capacitor C2 via capacitor C1, diode D1, diode D2, and zener diode D4. This DC voltage supplies current to the gate of triac 52 via resistor R3 rendering it conductive. MOSFET transistor M1 is initially in an off state allowing current to flow. After a predetermined period of time determined by the time constant of resistor R2 and capacitor C3, the voltage across capacitor C3 reaches the turn-on threshold of transistor M1, turning it on. This removes the gate current from triac 52 and triac 52 will now only remain conductive while current continues to flow through it. When current through triac 52 is interrupted, such as is the case when there is an arcing occurrence between lamp 20 and one of its lampholders, triac 52 turns off, thereby removing power from the lamp. The lamp-on control signal may be voltage-limited with zener diode D3. Bias resistor R1 limits current through zener diode D3 and the triac gate.

The arc protection circuit includes a lamp cutoff delay circuit 60, as shown back in FIG. 1. Lamp cutoff delay circuit 60 is electrically connected to lamp cutoff device 50. Exemplary lamp cutoff delay circuit 60 provides a lamp-on control signal to lamp cutoff device 50 to maintain lamp cutoff device 50 in a closed condition during a predetermined startup period when fluorescent lamp 20 is first being lit, or during subsequent attempts to be lit after an arc is detected and power is removed from fluorescent lamp 20. For example, a lamp-on control signal is applied to the gate of a triac or a power MOSFET serving as lamp cutoff device 50 during the startup period whether or not there is arcing in the lampholder, thereby providing fluorescent lamp 20 adequate time to ignite. In one example, gate current is supplied to the triac when electronic ballast 10 is turned on and continues to be supplied for at least a period of several hundreds of milliseconds until such time that a high voltage is detected across fluorescent lamp 20 and the gate current is removed.

The arc protection circuit may include a lamp restart circuit 70, as shown back in FIG. 1. Lamp restart circuit 70 is electrically connected to lamp cutoff device 50. Lamp restart circuit 70 provides a lamp-on control signal to lamp cutoff device 50 when a predetermined lamp-restart delay period has expired. For example, a lamp-off control signal is applied to the gate of a triac or a power MOSFET serving as lamp cutoff device 50 during the lamp-restart delay period to allow any heat generated by an arcing lampholder to dissipate, then a lamp-on control signal is applied after the lamp-restart delay period has been completed.

FIG. 3 shows a timing diagram of an arc protection circuit for a fluorescent lamp, in accordance with one embodiment of the present invention. The timing diagram shows lamp voltages 42 and lamp control signals 44 to the lamp cutoff device during characteristic operational modes of the invention.

At a time t0, power is applied to the electronic ballast. A high-frequency lamp voltage is applied across the fluorescent lamp, and a lamp-on control signal is applied to a lamp cutoff device in series with the fluorescent lamp. At some point during the startup period, the fluorescent lamp is ignited. In the case of an instant-start electronic ballast, an elevated voltage is applied to the ends of the fluorescent lamp during the startup period, which is then reduced during normal operation shown at time t1 when the fluorescent lamp is ignited. The arc detection circuit monitors for arcing in the lampholders.

When an arc in the lampholder is detected as indicated at time t2, a lamp-off control signal is generated and applied to the lamp cutoff device, power to the fluorescent lamp is removed, and a lamp-restart delay period is initiated.

At the end of the lamp-restart delay period, a restart may be attempted. At time t3, a lamp-on control signal is generated and applied to the lamp cutoff device. A ballast voltage is applied to the fluorescent lamp, and the fluorescent lamp is restarted. At the end of a re-startup period indicated at time t4, the fluorescent lamp is presumed to have restarted and normal operation is continued through a time t5 when the power to the fluorescent-lamp ballast circuit is removed and the fluorescent lamp is turned off.

FIG. 4 shows a flow diagram of a method of operating a fluorescent lamp, in accordance with one embodiment of the present invention.

A startup condition is determined, as seen at block 80. A determination is made whether a startup condition exists, such as detecting a line voltage applied to an fluorescent-lamp ballast circuit from the flipping of a wall switch, detecting an occupant in a room and applying line voltage to the electronic ballast, or cycling on after nighttime operation is completed.

When a startup condition is determined, power is applied to the fluorescent lamp, as seen at block 82. During a startup period, an instant-start electronic ballast may apply an elevated voltage to one or more fluorescent lamps in a fluorescent lamp fixture until the fluorescent lamps are ignited. Although an arcing condition may be detected during startup, power is maintained to the fluorescent lamp for a predetermined startup period.

The lamp ignites, as seen at block 84. A discharge along the length of the fluorescent lamp is generated within the fluorescent-lamp tube and sustained by continuation of lamp voltage applied to the fluorescent lamp.

While the fluorescent lamp is operating, an arc detection circuit monitors for an arcing condition, as seen at block 86. Monitoring for an arcing condition may comprise, for example, measuring a fluorescent-lamp voltage and comparing the measured voltage to a threshold value, or monitoring for an interruption of a fluorescent-lamp current.

When arcing is detected, power to the fluorescent lamp is blocked off, as seen at block 88. Blocking power to the fluorescent lamp may comprise, for example, sending a lamp-off control signal to a lamp cutoff device in series with the fluorescent lamp, or detecting an interruption in lamp current and turning off a lamp cutoff device in series with the fluorescent lamp due to reduced di/dt across the lamp cutoff device. In some cases, all the power applied to the fluorescent lamps is blocked; in other cases, a significant portion of the power is blocked.

When the lamp current is blocked off, a lamp-restart delay period may be initiated, as seen at block 90. The lamp-restart delay period may be initiated, for example, when the arcing condition is detected. The lamp-restart delay period may be selected to allow time for the arcing to be extinguished and for any heat generated in the vicinity of the arc to be dissipated.

When the lamp-restart delay period is expired, a lamp-on control signal may be provided to the lamp cutoff device in series with the fluorescent lamp, as seen at block 92. Power is then applied to the fluorescent lamp as seen back at block 82, and maintained across the fluorescent lamp until the lamp re-ignites, as seen at block 84. The steps from block 82 through block 92 may be repeated until the fluorescent light is turned off.

When power is removed from the fluorescent-lamp ballast circuit, the fluorescent lamp is turned off, as seen at block 94.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An electronic ballast for a fluorescent lamp (20), comprising:
a fluorescent-lamp ballast circuit (30);
an arc detection circuit (40) electrically connected to the fluorescent-lamp ballast circuit (30); and
a lamp cutoff device (50) in series with the fluorescent lamp (20) and electrically coupled to the arc detection circuit (40), wherein the fluorescent-lamp ballast circuit (30) provides power to the fluorescent lamp (20), and wherein the lamp cutoff device (50) is opened when arcing is detected by the arc detection circuit (40).

2. The ballast of claim 1 wherein the arc detection circuit (40) detects a lampholder arcing condition.

3. The ballast of claim 2 wherein the lampholder arcing condition comprises one of a lamp overvoltage condition or an interrupted lamp current condition.

4. The ballast of claim 1 wherein the lamp cutoff device (50) comprises a triac.

5. The ballast of claim 1 wherein the lamp cutoff device (50) comprises a power metal-oxide-semiconductor field-effect transistor.

6. The ballast of claim 1 further comprising:
a lamp cutoff delay circuit (60) electrically connected to the lamp cutoff device (50), wherein the lamp cutoff delay circuit (60) provides a lamp-on control signal to the lamp cutoff device (50) to maintain the lamp cutoff device (50) in a closed condition during a predetermined startup period.

7. The ballast of claim 1 further comprising:
a lamp restart circuit (70) electrically connected to the lamp cutoff device (50), wherein the lamp restart circuit (70) provides a lamp-on control signal to the lamp cutoff device (50) when a predetermined lamp restart delay period has expired.

8. An arc protection circuit for a fluorescent lamp (20), comprising:
an arc detection circuit (40); and
a lamp cutoff device (50) in series with the fluorescent lamp (20) and electrically coupled to the arc detection circuit (40), wherein the lamp cutoff device (50) is opened when arcing is detected by the arc detection circuit (40).

9. The arc protection circuit of claim 8 wherein the arc detection circuit (40) detects a lampholder arcing condition.

10. The arc protection circuit of claim 9 wherein the lampholder arcing condition comprises one of a lamp overvoltage condition or an interrupted lamp current condition.

11. The arc protection circuit of claim 8 wherein the lamp cutoff device (50) comprises a triac.

12. The arc protection circuit of claim 8 wherein the lamp cutoff device (50) comprises a power metal-oxide-semiconductor field-effect transistor.

13. The arc protection circuit of claim 8 further comprising:
a lamp cutoff delay circuit (60) electrically connected to the lamp cutoff device (50), wherein the lamp cutoff delay circuit (60) provides a lamp-on control signal to the lamp cutoff device (50) to maintain the lamp cutoff device (50) in a closed condition during a predetermined startup period.

14. The arc protection circuit of claim 8 further comprising:
a lamp restart circuit (70) electrically connected to the lamp cutoff device (50), wherein the lamp restart circuit (70) provides a lamp-on control signal to the lamp cutoff device (50) when a predetermined lamp restart delay period has expired.

15. A method of operating a fluorescent lamp (20), comprising:
monitoring for an arcing condition; and
blocking power to the fluorescent lamp (20) when the arcing condition is detected.

16. The method of claim 15 wherein monitoring for an arcing condition comprises measuring a fluorescent-lamp voltage and comparing the measured voltage to a threshold value.

17. The method of claim 15 wherein monitoring for an arcing condition comprises monitoring for an interruption of a fluorescent-lamp current.

18. The method of claim 15 wherein blocking power to the fluorescent lamp (20) comprises sending a lamp-off control signal to a lamp cutoff device (50) in series with the fluorescent lamp (20).

19. The method of claim 15 further comprising:
determining whether a startup condition exists; and
maintaining power to the fluorescent lamp (20) for a predetermined startup period based on the determination.

20. The method of claim 15 further comprising:
initiating a lamp restart delay period when the arcing condition is detected; and
providing a lamp-on control signal to a lamp cutoff device (50) in series with the fluorescent lamp (20) when the lamp restart delay period has expired.

21. An arc protection circuit for a fluorescent lamp, comprising:
an arc detection circuit (40), wherein the arc detection circuit (40) is connected in series with the fluorescent lamp (20), and wherein the arc detection circuit (40) is responsive to an interruption of current through the fluorescent lamp (20) as an indication of arcing; and
means for reducing lamp power supplied to the fluorescent lamp (20), wherein lamp power is reduced to the fluorescent lamp (20) when the interruption of current through the fluorescent lamp (20) is detected.
